(19) United States
(12) Patent Application Publication
(10) Pub. No.: US 2026/0121792 A1
(43) Pub. Date: Apr. 30, 2026

(54) Combining Adaptive Data Compression with Forward Error Correction to Attain Optimal Data Rates Under Varying Channel Conditions

(71) Applicant: The Government of the United States of America, as represented by the Secretary of the Navy, Arlington, VA (US)

(72) Inventors: Frederick Chache, Washington, DC (US); Sean Maxon, Washington, DC (US); Ramesh Bharadwaj, Washington, DC (US)

(73) Assignee: The Government of the United States of America, as represented by the Secretary of the Navy, Arlington, VA (US)

(21) Appl. No.: 18/902,806

(22) Filed: Sep. 30, 2024

Related U.S. Application Data
(63) Continuation of application No. 18/902,720, filed on Sep. 30, 2024.

(51) Int. Cl. H04L 1/00; H04L 69/04

(52) U.S. Cl. CPC H04L 1/0042; H04L 69/04

(57) ABSTRACT

Systems and methods are provided for allowing a device to increase the effective data rate and range of a communication link without the need to change any hardware or the waveform that the communication used prior. This can be done with adaptive changes to the forward error correction (FEC) settings and the compression ratio used. Embodiments of the present disclosure attain optimal data rates under varying channel conditions. This is very useful to improve legacy systems and to be backward compatible with them.

### CROSS REFERENCE TO RELATED APPLICATIONS

This application is a continuation of U.S. patent application Ser. No. 18/902,720, filed on Sep. 30, 2024, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; nrltechtran@us.navy.mil, referencing Navy Case Number 211428-US2.

### FIELD OF THE DISCLOSURE

This disclosure relates to communications, including data compression for communications.

### BACKGROUND

In 4G and other modern technologies, data rates can be improved by changing the waveform. This requires changes to hardware, which is impractical for legacy systems and maintaining backwards compatibility. For example, changing the waveform can involve changing it from 16-QAM to 64-QAM to improve the data rate or the data resilience based on network conditions. This method can be effective at increasing the range or data rate; however, it does require hardware changes and cannot be implemented in existing structures without significant and costly hardware changes.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1A is a diagram showing an exemplary system in accordance with an embodiment of the present disclosure;

FIG. 1B is a diagram showing another exemplary system in accordance with an embodiment of the present disclosure;

FIG. 2 is a flowchart of an exemplary method for estimating current channel signal to noise ratio (SNR) in accordance with an embodiment of the present disclosure;

FIG. 3 is a flowchart of an exemplary method for determining compressor settings and encoder settings in accordance with an embodiment of the present disclosure;

FIG. 4 is a flowchart of another exemplary method for determining compressor settings and encoder settings in accordance with an embodiment of the present disclosure;

FIG. 5 is a diagram showing exemplary normalized data rate vs. distance in accordance with an embodiment of the present disclosure;

FIG. 6 is a diagram showing an exemplary plot of signal to noise ratio (SNR) to the number of byte errors in accordance with an embodiment of the present disclosure; and

FIG. 7 is a diagram showing exemplary model validation results in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. OVERVIEW

Embodiments of the present disclosure allow a device to increase the effective data rate and range of a communication link without the need to change any hardware or the waveform that the communication used prior. This can be done with adaptive changes to the forward error correction (FEC) settings and the compression ratio used. Embodiments of the present disclosure attain optimal data rates under varying channel conditions. This is very useful to improve legacy systems and to be backward compatible with them.

In an embodiment, as data is generated from a sensor or other source, data is transmitted after undergoing compression and encoding. As packets are transmitted, data acknowledgments are received. Using this information, basic channel models can be developed. As nodes move or channel quality changes, the channel model can recognize these changes and, with knowledge of the queue size, adjust the compressor and encoder settings to optimize the data rates for the given conditions. Embodiments of the present disclosure allow devices to adjust the effective data rate and data resilience based on network channel conditions in real time. This allows higher data rates or longer ranges depending on the situation.

### 2. EXEMPLARY SYSTEMS

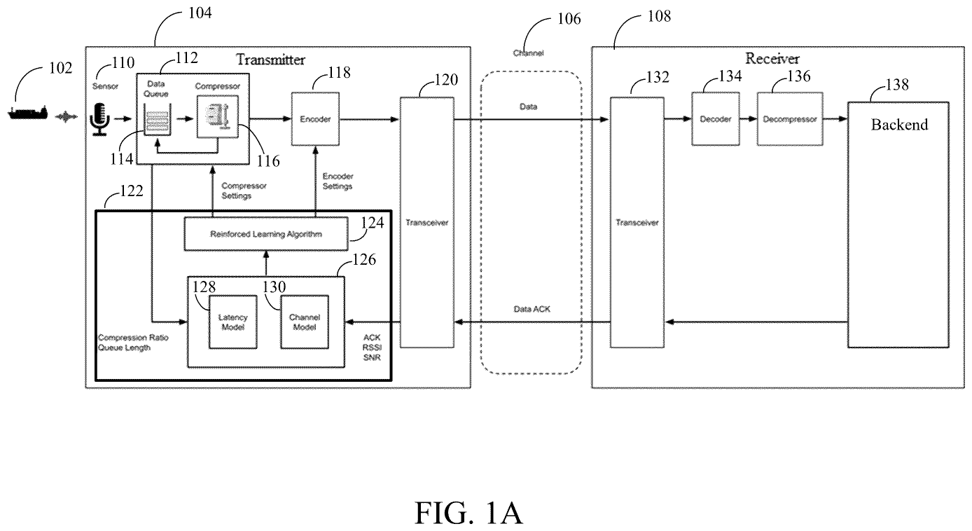

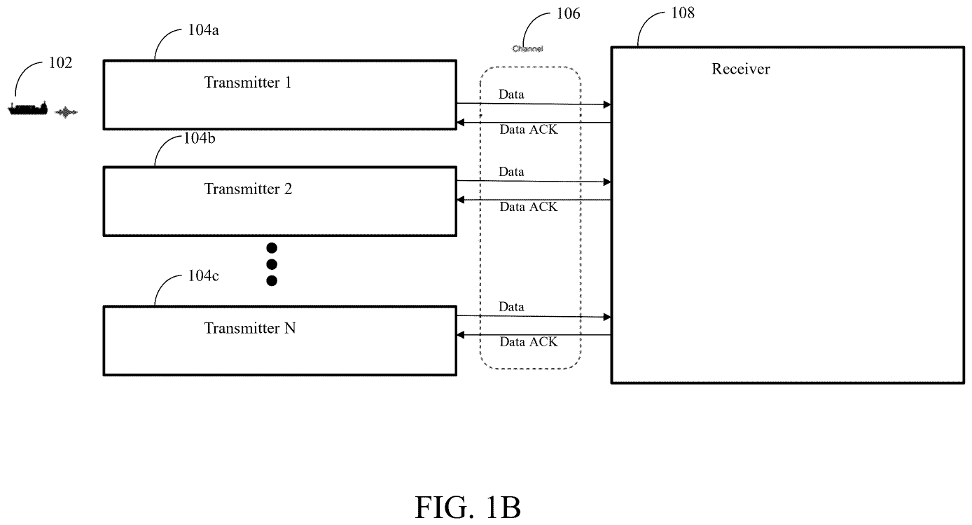

FIG. 1A is a diagram showing an exemplary system in accordance with an embodiment of the present disclosure. In FIG. 1A, a transmitter 104 is in communication with a platform 102. In an embodiment, platform 102 is a ship. In FIG. 1A, transmitter 104 communicates over a channel 106 with a receiver 108. In an embodiment, the system of FIG. 1A improves how much data can be sent from transmitter 104 to platform 102. For example, in an embodiment, transmitter 104 includes sensor 110, which can sense feedback from platform 102. In an embodiment, sensor 110 can collect data, and transmitter 104 can send a reply to platform 102, tweaking how it transmits data to see how it can be best used by platform 102.

In an embodiment, transmitter 104 can be initialized with a model of what the channel between platform 102 and transmitter 104 looks like. In an embodiment, this model is a general initialized model that can update itself and can be initialized with some baseline numbers. In an embodiment, sensor 110 is an acoustic sensor; however, it should be understood that sensor 110 can also be any sensor or sensors that can work with digital data, e.g., image data, infrared, etc., in accordance with embodiments of the present disclosure.

In an embodiment, transmitter 104 and receiver 108 can be implemented using separate devices. In an embodiment, transmitter 104 is at a data collection center within communication range of platform 102. In an embodiment, receiver 108 can collect data from multiple transmitters 104 (e.g., as shown in FIG. 1B).

Components of transmitter 104 and receiver 108 will now be discussed with reference to FIG. 1A. In an embodiment, transmitter 104 includes a data compressor 112. In an embodiment, data compressor 112 includes a data queue 114 and a compressor 116. In an embodiment, transmitter 104 includes an encoder 118, such as an error correcting encoder. In an embodiment, transmitter 104 further includes a transceiver 120 and a controller 122. In an embodiment, controller 122 includes a decision making algorithm with a reinforced learning algorithm 124 and a model 126, including a latency model 128 and a channel model 130. In an embodiment, receiver 108 includes a transceiver 132, a decoder 134, a decompressor 136, and a backend 138 (e.g., a backend device and/or a backend application).

In an embodiment, data from sensor 110, goes to data compressor 112, which does forward error correction (FEC) according to compressor settings from controller 122, which can modify how to select which FEC/data compression schemes to use for individual packets. In an embodiment, the error corrected data is sent to encoder 118 for encoding based on encoder settings from controller 122. In an embodiment, the encoded data is transmitted over channel 106 by transceiver 120. In an embodiment, transceiver 132 sends the data to decoder 134, which sends the data to decompressor 136, which sends the data to backend 138. In an embodiment, transceiver 120 receives a data acknowledgement (ACK) signal from transceiver 132 of receiver 108 and transmits an ACK signal to controller 122.

In an embodiment, as transmitter 104 collects data, controller 122 updates models in real time and can change corresponding compressor settings and encoder settings based on the updated models. In an embodiment, these settings affect the likelihood that a packet is transmitted successfully. If transmitted successfully, transceiver 132 in receiver 108 generates an ACK; if not, transceiver 132 in receiver 108 generates no ACK.

In an embodiment, adjusting compressor and encoder settings entails adjusting the data rate from sensor 110 to platform 102. For example, there is a limited amount of channel, and the more FEC is used, the more overhead there is with less space for data. Embodiments of the present disclosure reduce FEC to get the most data and still get an ACK.

In an embodiment, backend 138 can support a backend application that uses sensor data (e.g., remote monitoring of a ship, such as a visual display of video feed of what sensor 110 is monitoring). In an embodiment, sometimes there can be data requirements from the backend application that can send information/feedback to transmitter 104. For example, in an embodiment, if data is too noisy, backend 138 can send a signal to transceiver 132 to request less compression (e.g., by setting a noise tolerance threshold), and transceiver 132 can send this signal over channel 106 to transceiver 120, which can relay this information to controller 122 to adjust corresponding compressor settings and/or encoder settings. For example, both compression and FEC can affect data rate because they add overhead; more compression decreases overhead but adds more noise, and more FEC increases overhead but improves the distance over which data can be transmitted.

FIG. 1B is a diagram showing another exemplary system in accordance with an embodiment of the present disclosure. FIG. 1B shows an embodiment with multiple transmitters 104a, 104b, and 104c in communication with platform 102 and receiver 108. As illustrated by FIG. 1B any number of transmitters 104 can be used in accordance with embodiments of the present disclosure. In an embodiment, transmitters 104 can be lower power devices, and receiver 108 can be implemented on a more expensive centralized device.

Components for transmitters 104 and receiver 108 can be implemented using hardware, software, and/or a combination of hardware and software. Components for transmitters 104 and receiver 108 can be implemented using a single device or multiple devices. Components for transmitters 104 and receiver 108 can be implemented using special purpose devices or general purpose devices. In an embodiment, receiver 108 can be implemented using a general purpose computer or a special purpose device. In an embodiment, transmitters 104 can be implemented using general purpose devices or special purpose devices. Controller 122 can be implemented using hardware, software, and/or a combination of hardware and software. Controller 122 can be implemented using a single device or multiple devices. Controller 122 can be implemented using a general purpose device or a special purpose device.

### 3. EXEMPLARY CONTROLLER AND DECISION MAKING ALGORITHM

In an embodiment, controller 122 determines and sets compression and encoding settings for data compressor 112 and encoder 118. In an embodiment, controller 122 determines these settings based on ACKs/lack thereof from receiver 108 and/or requests from backend application, e.g., regarding noise/latency requests. In an embodiment, controller 122 further receives a received signal strength indicator (RSSI) from transceiver 120, which can be used to figure out the distance to platform 102 and the channel quality. In an embodiment, controller 122 further receives a signal to noise ratio (SNR) from transceiver 120.

In an embodiment, controller 122 uses the ACK, RSSI, SNR, compression ratio, and encoder settings (e.g., the encoder settings currently being sent to encoder 118) and uses these inputs to update channel model 130 and/or latency model 128. In an embodiment, controller 122 uses the ACK, RSSI, SNR, compression ratio, encoder settings, and/or queue length and processes it (e.g., using reinforced learning algorithm 124) to adjust encoder settings and compressor settings. In an embodiment, channel model 130 calculates an estimate of channel SNR from information received from ACK messages from receiver 108. In an embodiment inputs to channel model 130 include the ACK, RSSI, SNR, FEC settings used (e.g., coding Rate), and size of packet transmitted.

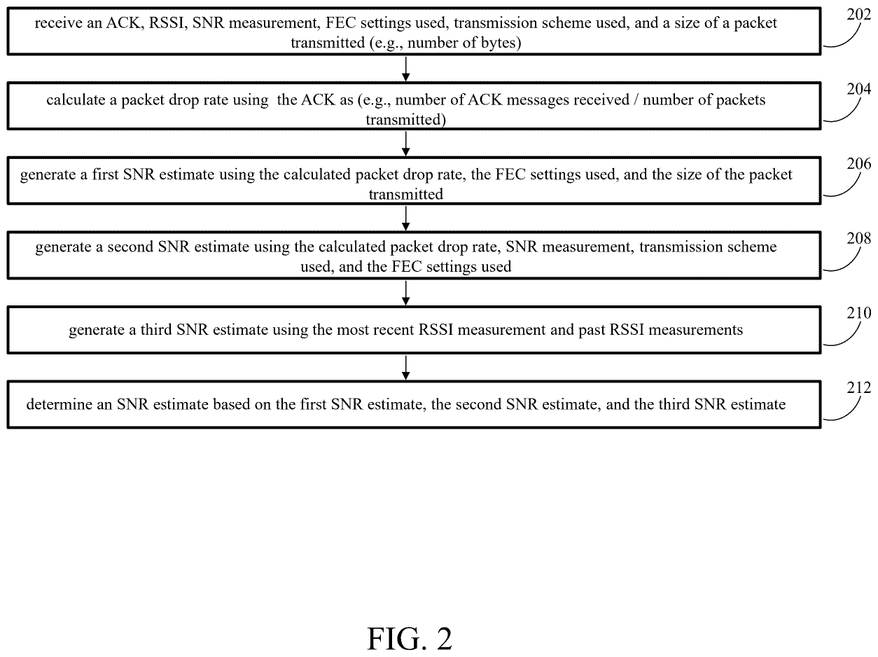

FIG. 2 is a flowchart of an exemplary method for estimating current channel signal to noise ratio (SNR) in accordance with an embodiment of the present disclosure. In step 202, an ACK, RSSI, SNR measurement, FEC settings used, transmission scheme used, and a size of a packet transmitted (e.g., number of bytes) are received. For example, in an embodiment, controller 122 receives the ACK, RSSI, and SNR measurement from transceiver 120 and knows the FEC settings used, transmission scheme used, and a size of a packet transmitted based on the current settings of transmitter 104.

In step 204, a packet drop rate is calculated (e.g., by controller 122) using the ACK as (e.g., number of ACK messages received/number of packets transmitted). In step 206, a first SNR estimate is generated (e.g., by controller 122) using the calculated packet drop rate, the FEC settings used, and the size of the packet transmitted. In step 208, a second SNR estimate is generated (e.g., by controller 122) using the calculated packet drop rate, SNR measurement, transmission scheme used, and the FEC settings used. In step 210, a third SNR estimate is generated (e.g., by controller 122) using the most recent RSSI measurement and past RSSI measurements. In step 212, an SNR estimate is determined (e.g., by controller 122) based on the first SNR estimate, the second SNR estimate, and the third SNR estimate.

For example, in an embodiment, an average of the three SNR estimates can be calculated to determine the SNR estimate to be used. In an embodiment, if some measurements are not available due to transceiver hardware use the available estimates in a sensor fusion algorithm. In an embodiment, this is done using the three measurements to allow for use over a wider range of hardware as not all transceivers provide RSSI or SNR measurements directly. In an embodiment, this would be configured for the specific hardware use case; additionally this allows for model checking so if one method is an outlier from the others it can be flagged as unreliable. In an embodiment, the above steps can be performed by channel model 130 of controller 122.

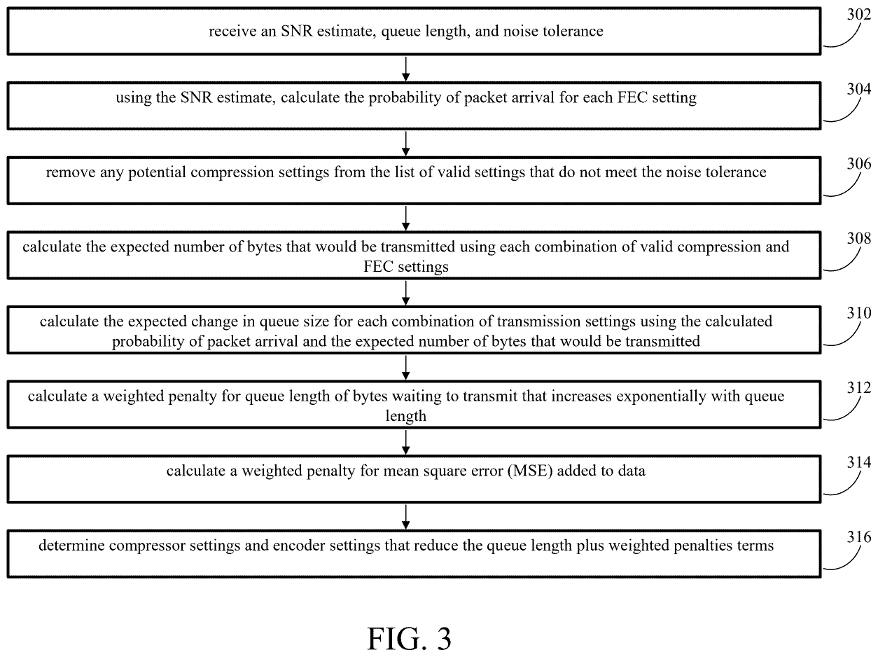

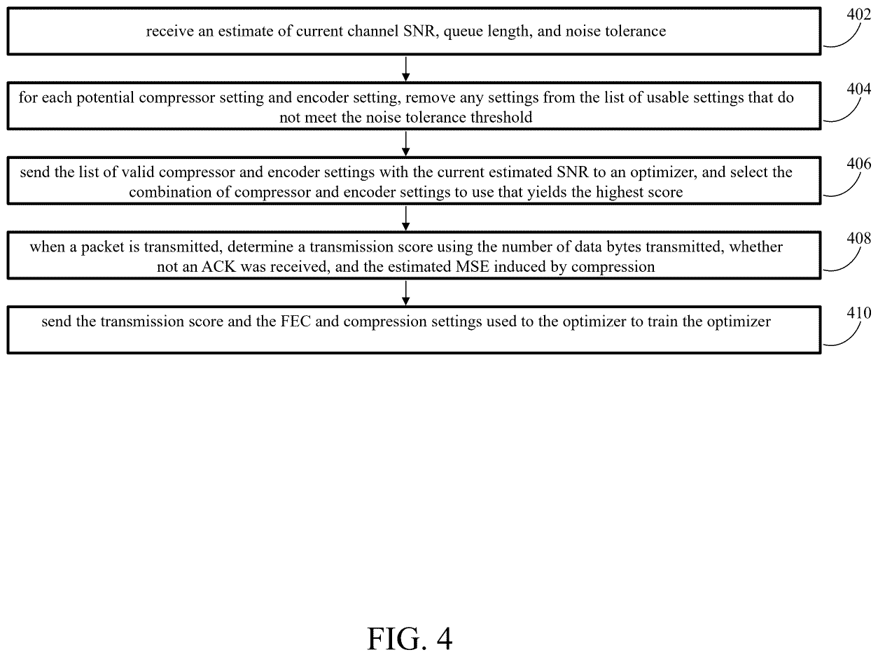

FIG. 3 is a flowchart of an exemplary method for determining compressor settings and encoder settings in accordance with an embodiment of the present disclosure. FIG. 3 shows a method for calculating compressor settings and encoder settings using communication theory, and FIG. 4 shows a machine learning method for calculating compressor settings and encoder settings. The method of FIG. 4 calculates what settings are expected to provide the best performance. It seeks to minimize the queue length, to minimize latency, but contains a penalty term to force the system to favor using lower compression rates, which induce less noise, when the queue length is low and thus latency is low. As the queue length increases, a queue length penalty term forces it to shift to higher compression ratios as the channel quality decreases, either from channel SNR, or from packet collisions from high levels of traffic on a shared channel

In step 302, an SNR estimate, queue length, and noise tolerance are received. For example, in an embodiment, controller 122 receives the SNR estimate from transceiver 132 and the noise tolerance from an application running on backend 138. In an embodiment, the queue length can be received from transceiver 132 or can be known by controller 122 based on current settings.

In step 304, using the SNR estimate, the probability of packet arrival for each FEC setting is calculated (e.g., by controller 122). In an embodiment, this is done by assuming a binomial model and distribution of byte errors. For a given FEC setting, a fixed number of byte errors can be tolerated, and using this information, the probability that the number of byte errors exceeds a given threshold can be calculated.

In step 306, any potential compression settings from the list of valid settings that do not meet the noise tolerance are removed (e.g., by controller 122). In step 308, the expected number of bytes that would be transmitted using each combination of valid compression and FEC settings are calculated (e.g., by controller 122). In an embodiment, this is done using the expected compression ratio and the coding rate of the FEC algorithm. In step 310, the expected change in queue size for each combination of transmission settings is calculated using the calculated probability of packet arrival and the expected number of bytes that would be transmitted (e.g., by controller 122).

In optional step 312, a weighted penalty for queue length of bytes waiting to transmit is calculated for each combination of transmission settings that increases exponentially with queue length (e.g., by controller 122). In an embodiment, this term is to penalize long queue lengths which is an efficient way to generate a rough estimate of latency. In optional step 314, a weighted penalty for mean square error (MSE) added to data is calculated for each combination of transmission settings (e.g., by controller 122).

In step 316, compressor settings and encoder settings are determined (e.g., by controller 122) that reduce the queue length plus (optional) weighted penalties terms. In an embodiment, controller 122 can use these determined compressor settings and encoder settings as inputs to data compressor 112 and encoder 118.

In an embodiment, after a predetermined number of packets are transmitted, controller 122 can calculate the amount of noise induced and the average compression ratio achieved for each compression setting. In an embodiment, this is computationally expensive if done every packet transmission, so this can be done on occasion. In an embodiment, transmitter 104 compresses the data with each of the lossy compression settings and then compares the recovered data to the original data. In this way, transmitter 104 (e.g., using controller 122) can calculate the mean square error (MSE) induced.

FIG. 4 is a flowchart of another exemplary method for determining compressor settings and encoder settings in accordance with an embodiment of the present disclosure. The flowchart of FIG. 4 uses a machine learning approach for latency modeling. In an embodiment, the method of FIG. 4 uses a Bayes optimizer that is initialized with random initial values.

In step 402, when transmitter 104 wants to transmit data, an estimate of current channel SNR, queue length, and noise tolerance is received. For example, in an embodiment, controller 122 receives the SNR estimate from transceiver 132 and the noise tolerance from an application running on backend 138. In an embodiment, the queue length can be received from transceiver 132 or can be known by controller 122 based on current settings.

In step 404, for each potential compressor setting and encoder setting, any settings from the list of usable settings that do not meet the noise tolerance threshold are removed (e.g., using controller 122). In step 406, the list of valid compressor and encoder settings with the current estimated SNR are sent to an optimizer, and the combination of compressor and encoder settings to use that yields the highest score is selected (e.g., using controller 122). In an embodiment, controller 122 can use these determined compressor settings and encoder settings as inputs to data compressor 112 and encoder 118.

In optional step 408, when a packet is transmitted, a transmission score, whether not an ACK was received, and the estimated MSE induced by compression are determined (e.g., using controller 122). In optional step 410, the transmission score and the FEC and compression settings used are sent to the optimizer to train the optimizer.

In an embodiment, after a predetermined number of packets are transmitted, controller 122 can calculate the amount of noise induced and the average compression ratio achieved for each compression setting. In an embodiment, this is computationally expensive if done every packet transmission, so this can be done on occasion. In an embodiment, transmitter 104 compresses the data with each of the lossy compression settings and then compares the recovered data to the original data. In this way, transmitter 104 (e.g., using controller 122) can calculate the MSE induced.

### 4. EXEMPLARY RESULTS

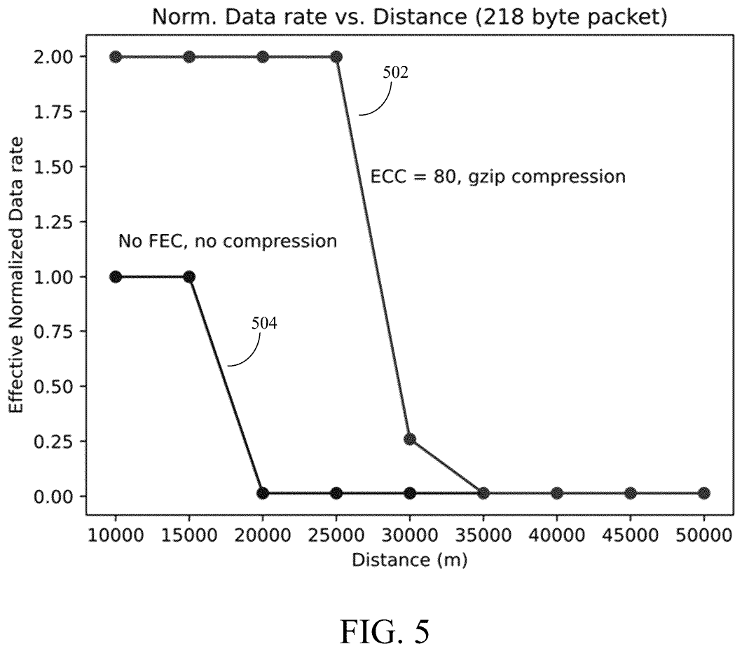

FIG. 5 is a diagram showing exemplary normalized data rate vs. distance in accordance with an embodiment of the present disclosure. In FIG. 5, the top plot 502 shows results using an embodiment of the present disclosure, and the bottom plot 504 shows results without using an embodiment of the present disclosure. In FIG. 5, the results pictured show the effective normalized data rate, which includes the effects of compression (evident at near distances) and error correction (most evident at far distances). In the simulation for FIG. 5, a hydrophone audio data set was used with a standard frequency shift keying (FSK) channel model for capacity values.

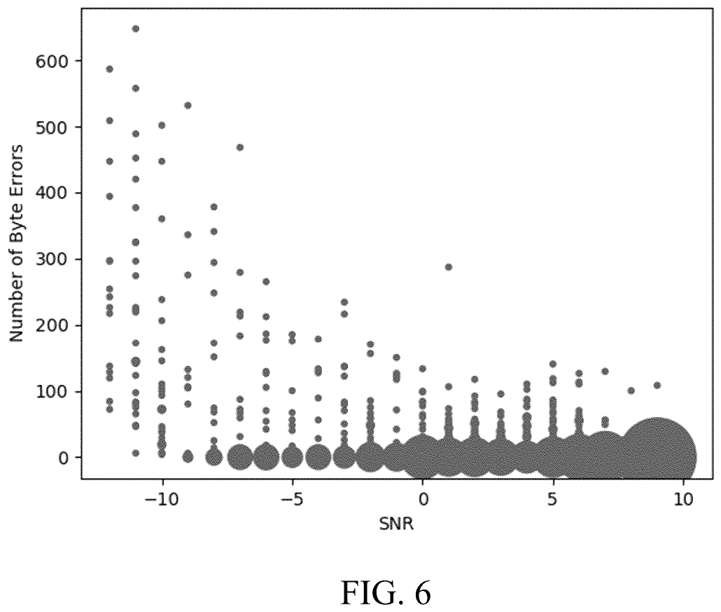

FIG. 6 is a diagram showing an exemplary plot of signal to noise ratio (SNR) to the number of byte errors in accordance with an embodiment of the present disclosure. For FIG. 6, a simulation model was verified by experimental data collected on hardware. Known packets of fixed size were transmitted, and the number of corrupted bytes in each packet was counted. In FIG. 6, the error count was plotted against measured SNR at the receiver.

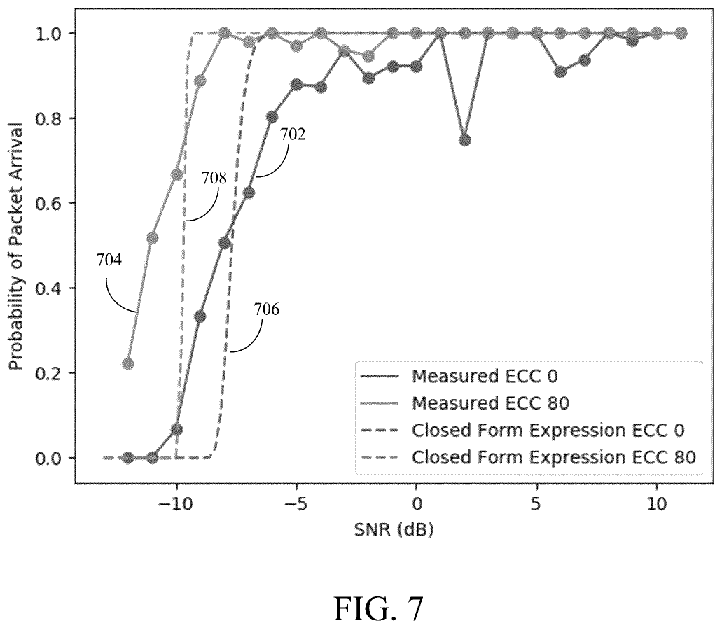

FIG. 7 is a diagram showing exemplary model validation results in accordance with an embodiment of the present disclosure. FIG. 7 shows plots for measured error correction code (ECC) 0 702, measured ECC 80 704, closed form expression ECC 0 706, and closed form expression ECC 80 708.

### 5. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented using a computer program executing on a machine, using a computer program product, or using a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A transmitter, comprising:
a data compressor configured to:
receive data to be transmitted, and
compress the data based on compressor settings, thereby generating compressed data;
an encoder coupled to the data compressor, wherein the encoder is configured to:
encode the data based on the encoder settings, thereby generating encoded data; and
a controller, coupled to the data compressor and the encoder, wherein the controller is configured to:
receive an acknowledgement signal (ACK) from a receiver, a received signal strength indicator (RSSI), a signal to noise ratio (SNR), forward error correction settings used, a transmission scheme used, and a size of a packet transmitted,
generate a plurality of SNR estimates based on the received signal strength indicator (RSSI), the signal to noise ratio (SNR), the forward error correction settings used, the transmission scheme used, and the size of the packet transmitted,
determine a SNR estimate based on the plurality of generated SNR estimates,
update a channel model based on the determined SNR estimate,
calculate updated compressor settings and updated encoder settings based on the updated channel model,
send the updated compressor settings to the data compressor, and
send the updated encoder settings to the encoder.

2. The transmitter of claim 1, wherein the controller is further configured to:
calculate a packet drop rate using the ACK.

3. The transmitter of claim 1, wherein the controller is further configured to:
generate a first SNR estimate in the plurality of SNR estimates using the calculated packet drop rate, the FEC settings used, and the size of the packet transmitted.

4. The transmitter of claim 3, wherein the controller is further configured to:
generate a second SNR estimate in the plurality of SNR estimates using the calculated packet drop rate, the SNR, the transmission scheme used, and the FEC settings used.

5. The transmitter of claim 4, wherein the controller is further configured to:
generate a third SNR estimate in the plurality of SNR estimates using a most recent RSSI measurement and a past RSSI measurement.

6. A transmitter, comprising:
a data compressor configured to:
receive data to be transmitted, and
compress the data based on compressor settings, thereby generating compressed data;
an encoder coupled to the data compressor, wherein the encoder is configured to:
encode the data based on encoder settings, thereby generating encoded data; and
a controller, coupled to the data compressor and the encoder, wherein the controller is configured to:
receive an acknowledgement signal (ACK) from a receiver, a received signal strength indicator (RSSI), a signal to noise ratio (SNR), a queue length, and a noise tolerance threshold,
update a channel model based on the ACK, the RSSI, and the SNR,
remove any potential compressor settings that do not satisfy the noise tolerance threshold,
determine an expected change in queue size for each combination of potential compressor settings and encoder settings,
determine updated compressor settings and updated encoder settings, based on the updated channel model, such that the updated compressor settings and updated encoder settings reduce the queue length,
send the updated compressor settings to the data compressor, and
send the updated encoder settings to the encoder.

7. The transmitter of claim 6, wherein the controller is further configured to:
determine a probability of a packet arrival for each potential encoder setting based on the updated channel model.

8. The transmitter of claim 6, wherein the controller is further configured to:
determine a probability of a packet arrival for each potential encoder setting based on an updated SNR estimate in the updated channel model.

9. The transmitter of claim 6, wherein the controller is further configured to:
determine an expected number of bytes that would be transmitted using each potential compressor setting and encoder setting.

10. The transmitter of claim 6, wherein the controller is further configured to:
determine a probability of packet arrival for each potential encoder setting.

11. The transmitter of claim 10, wherein the controller is further configured to:
determine the expected change in queue size for each potential compressor setting and encoder setting using the determined expected number of bytes that would be transmitted and the determined probability of packet arrival.

12. The transmitter of claim 6, wherein the controller is further configured to:
calculate a first weighted penalty for queue length of bytes waiting to transmit that increases exponentially with queue length.

13. The transmitter of claim 12, wherein the controller is further configured to:
calculate a second weighted penalty for mean square error (MSE) added to data.

14. The transmitter of claim 13, wherein the controller is further configured to:
determine the updated compressor settings and updated encoder settings based on the first weighted penalty and the second weighted penalty.

15. A transmitter, comprising:
a data compressor configured to:
receive data to be transmitted, and
compress the data based on compressor settings, thereby generating compressed data;
an encoder coupled to the data compressor, wherein the encoder is configured to:
encode the data based on encoder settings, thereby generating encoded data; and
a controller, coupled to the data compressor and the encoder, wherein the controller is configured to:
receive an acknowledgement signal (ACK) from a receiver, a received signal strength indicator (RSSI), a signal to noise ratio (SNR), a queue length, and a noise tolerance threshold,
update a channel model based on the ACK, the RSSI, and the SNR,
remove potential compressor settings and potential encoder settings that do not meet the noise tolerance threshold,
send a list of valid potential compressor settings and valid potential encoder settings to an optimizer,
determine, using the optimizer, updated compressor settings and an updated encoder settings that yield a highest score determined by the optimizer,
send the updated compressor settings to the data compressor, and
send the updated encoder settings to the encoder.

16. The transmitter of claim 15, wherein the controller is further configured to:
determine a current estimated SNR based on the updated channel model; and
send the current estimated SNR to the optimizer.

17. The transmitter of claim 15, wherein the controller is further configured to:
determine, when a packet is transmitted, a transmission score; and
send the transmission score to the optimizer for training.

18. The transmitter of claim 17, wherein the controller is further configured to:
send corresponding encoder and compression settings used when the packet is transmitted to the optimizer for training.

19. The transmitter of claim 17, wherein the controller is further configured to:
determine the transmission score using a number of data bytes transmitted, whether or not a corresponding ACK was received, and an estimate mean square error (MSE) induced by compression.

20. The transmitter of claim 15, wherein the optimizer is a Bayes optimizer.
